(19) United States
(12) Patent Application Publication
(10) Pub. No.: US 2003/0103036 A1
(43) Pub. Date: Jun. 5, 2003

(54) Data relaying device, data relaying system, and data relaying method capable of switching data among servers

(75) Inventor: Yoshinori Nakamura, Tokyo (JP)

Correspondence Address: SUGHRUE MION, PLLC, 2100 Pennsylvania Avenue, NW, Washington, DC, 20037-3213, US

(73) Assignee: NEC CORPORATION

(21) Appl. No.: 10/307,456

(22) Filed: Dec. 2, 2002

(30) Foreign Application Priority Data
Nov. 30, 2001 (JP) 366689/2001

(51) Int. Cl. G09G 5/00

(52) U.S. Cl. 345/156

(57) ABSTRACT

A data relaying device is provided which is capable of transmitting data created by one server to another server without a need for forming telecommunication circuit networks. The data relaying device is made up of a storing request section to make a request for duplication of data being stored in any one(s) of a plurality of servers in accordance with instructions fed through data inputting devices, an input data switching section to input duplicated data in response to a request from the storing request section, a data storing section to store data input by the input data switching section, and output data switching sections to output data being stored in the data storing section to other server in accordance with instructions input by the output data switching section.

### BACKGROUND OF THE INVENTION

1. Field of the Invention

The present invention relates to a data relaying device, a data relaying system, and a data relaying method, and more particularly to the data relaying device, the data relaying system and the data relaying method enabling data to be switched among servers.

The present application claims priority of Japanese Patent Application No.2001-366689 filed on Nov. 30, 2001, which is hereby incorporated by reference.

2. Description of the Related Art

A conventional computer system is provided with a keyboard and a mouse serving together as data inputting devices, servers such as N pieces of personal computers, workstations or like, and a data relaying device such as an adapter to relay data input from the data inputting devices and to directly output the data to any one of the servers.

When a user or a like of the servers manipulates, for example, the data inputting device to input document data or a like, with a specified server to which data is to be received being previously selected by the data relaying device, the document data or the like input by the user or the like of the servers is output to the specified server which has been selected by the data relaying device.

Moreover, a method is disclosed in, for example, Japanese Patent Application Laid-open No. Hei 11-31064 in which a plurality of display devices is prepared and one mouse is connected to each of the display devices using a unit which can switch a device to which the mouse is to be connected. In the disclosed method, common coordinates to be commonly used as coordinates for, for example, two display screens of the display devices are provided which are laid out in a manner that the common coordinates are arranged in the same manner used for each of the two display screens and, when a cursor on a first screen out of the two screens being operated at the common coordinates goes over a boundary being adjacent to a second screen of the two display screens, a screen to be used is switched and the cursor is made to appear at a position on the second screen being successively continued to an final position of the cursor on the first screen.

Thus, in the conventional technology, by operating as above, screens of two or more display devices, even though the two display devices or their OSs (Operating Systems) are heterogeneous, can be switched to one another simply by moving a cursor, using a keyboard and a mouse being used together or being used separately.

However, the conventional technology presents a problem in that, since telecommunication circuit networks are not formed among display devices, it is impossible to transmit an image being displayed on one display device to other display device. Here, presuming in the example that servers are used instead of the display devices, when a document is created by one server and the same document wants to be used in another server, the same document has to be newly created again by another server and the telecommunication circuit networks have to be organized by constructing a LAN (Local-Area Network) so that the data can be transmitted and received among the servers.

However, in order to construct such the LAN or a like, a specified program has to be prepared individually for each server and therefore transmission and receipt of data among the servers are impossible unless each server is operated according to a specified OS. Moreover, when the telecommunication circuit networks are to be introduced, additional complicated work is required for constructing such the LAN or the like and, in some cases, it is not easy to ensure reliability required when data is transmitted and/or received.

### SUMMARY OF THE INVENTION

In view of the above, it is an object of the present invention to provide a data relaying device, a data relaying system, and a data relaying method which are capable of transmitting data created by one server to another server without a need for organizing telecommunication circuit networks.

According to a first aspect of the present invention, there is provided a data relaying device for relaying data from a data inputting device to a plurality of servers and for outputting data input by the data inputting device to any one of the servers including:

a storing request section to make a request for duplication of data being held by any one of the plurality of servers in accordance with instructions input by the data inputting device;

an inputting section to input data being duplicated according to a request from the storing request section;

a data storing section to store data input by the inputting section; and

an outputting section to output data being stored in the data storing section, in accordance with instructions input by the data inputting device, to another one or more of the plurality of servers.

In the foregoing, a preferable mode is one that wherein includes a switching section to switch a device to be connected to any one of the servers between the data inputting device and the data storing section.

Also, a preferable mode is one wherein the storing request section stores data input by the data inputting device to the data storing section.

Also, a preferable mode is one wherein the data inputting device is any one of a keyboard, a mouse, a ten-key pad, a joy stick, and a track ball.

According to a second aspect of the present invention, there is provided a data relaying system including:

a data inputting device;

a plurality of servers; and

a data relaying device for relaying data from the data inputting device to the plurality of servers and for outputting data input by the data inputting device to any one of the servers, the data relaying system having; a storing request section to make a request for duplication of data being held by any one of the plurality of servers in accordance with instructions input by the data inputting device; an inputting section to input data being duplicated according to a request from the storing request section; a data storing section to store data input by the inputting section; and an outputting section to output data being stored in the data storing section, in accordance with instructions input by the data inputting device, to another one or more of the plurality servers.

According to a third aspect of the present invention, there is provided a data relaying method including:

a step of outputting data input by a data inputting device to any one of a plurality of servers;

a step of duplicating data being held by any one of the plurality of servers and of storing the duplicated data to a data storing section in advance; and

a step of outputting data being stored in the data storing section to another one or more of the plurality of servers.

With the above configuration, data created by one server can be transmitted to another server without a need for forming telecommunication circuit networks.

With another configuration as above, data having a same content can be output to a plurality of servers by simplified operations.

### BRIEF DESCRIPTION OF THE DRAWINGS

The above and other objects, advantages, and features of the present invention will be more apparent from the following description taken in conjunction with the accompanying drawings in which:

FIG. 1 is a schematic block diagram showing configurations of a data relaying system according to an embodiment of the present invention; and

FIG. 2 is a sequence diagram showing operations of the data relaying system of FIG. 1.

### DETAILED DESCRIPTION OF THE PREFERRED EMBODIMENTS

Best modes of carrying out the present invention will be described in further detail using various embodiments with reference to the accompanying drawings.

### Embodiment

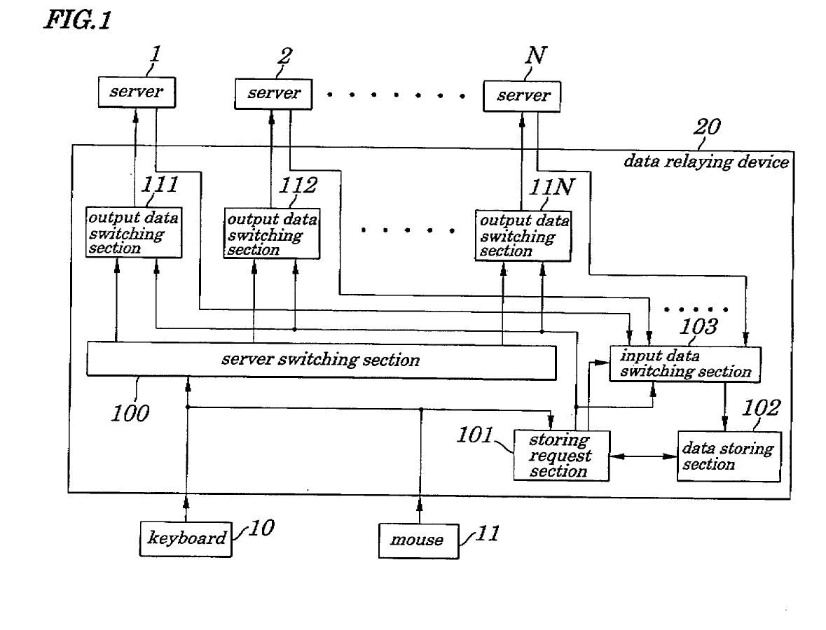

FIG. 1 is a schematic block diagram showing configurations of a computer system provided with a data relaying system according to an embodiment of the present invention. As shown in FIG. 1, the computer system according to this embodiment includes a keyboard 10 and a mouse 11 both serving as data inputting devices, servers 1 to N such as N pieces of personal computers to which monitors are connected, and the data relaying device 20 such as an adapter for outputting data input by the keyboard 10 or a like to any one of the servers 1 to N, or for duplicating, in accordance with instructions input by the keyboard 10, data being held in any one of the servers 1 to N and then for outputting the duplicated data to another one of the servers 1 to N in this system.

Moreover, each of the servers 1 to N, when receiving a request for duplication of data transmitted from the data relaying device 20, performs the duplication processing, for example, by using software.

The data relaying device 20 is made up of a storing request section 101 to make the request for duplication of data being stored in the servers 1 to N in accordance with instructions input through the keyboard 10 or the like by a user or a like of the servers 1 to N and/or to store data input through the keyboard 10 by the user or a like of the servers 1 to N into a data storing section 102, the data storing section 102 to store data duplicated in response to a request for the duplication fed from the storing request section 101, an input data switching section 103 to switch connection to either of the data storing section 102 or any one of the servers 1 to N, a server switching section 100 to select a device to which data input by the keyboard 10 or the like is to be output, and output data switching sections 111 to 11N to switch selectively outputting of data being stored in the data storing section 102 and data fed from the server switching section 100.

Moreover, the servers 1 to N to which the present invention can be applied include, besides servers in personal computers, communication servers used to exert control on communications, file servers used to enable a file to be shared, printing servers used to enable a printer to be shared, and data base servers used to enable a data base to be shared.

Also, the request for duplication of data to any one of the servers 1 to N may be made by mounting, for example, a button adapted to be pressed down by the user on the data relaying device 20 to input instructions with ON-OFF control of the button or by pressing down a function key, a control key, or a shift key on the keyboard 10 to input the instruction.

Furthermore, instead of the keyboard 10 and the mouse 11, other data inputting devices such as a ten-key pad, a joy stick, a track ball, or a like may be used.

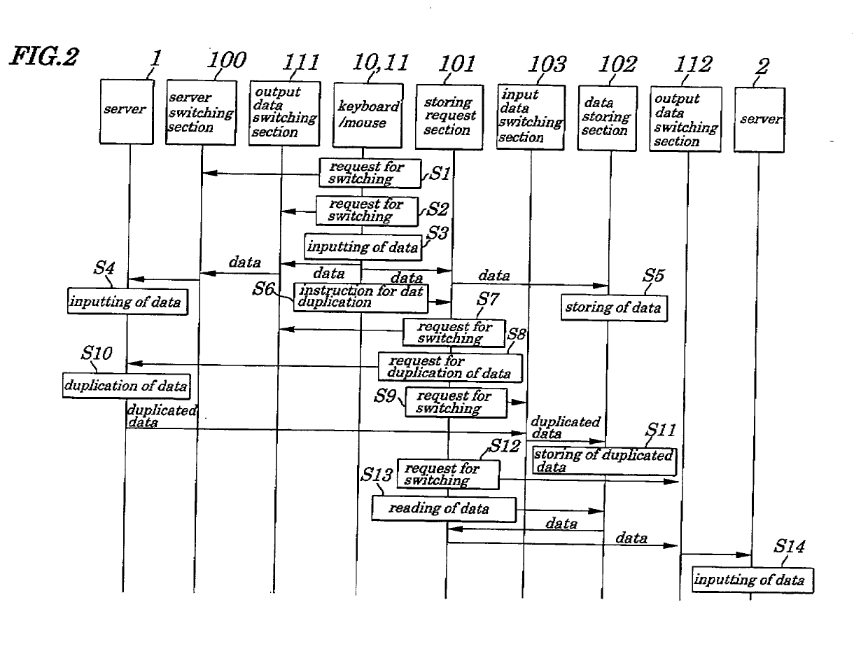

Next, operations of the data relaying system are described by referring to FIG. 2. FIG. 2 is a sequence diagram showing operations of the data relaying system of FIG. 1. First, for example, if the user of the servers 1 to N wants to create a document or a like by using the server 1, the user inputs instructions through the keyboard 10 so that switching is done by the server switching section 100 to select the server 1 (Step S1).

Then, switching is done by the output data switching section 111 to select the server switching section 100 (Step S2).

In the state described above, data is input by using the keyboard 10 or the mouse 11 (Step S3).

Then, the data is transmitted through the server switching section 100 and the output data switching section 111 in the data relaying device 20 and is input to the server 1 (Step S4).

This enables the user to create the document while seeing characters being displayed on a monitor connected to the server 1. Moreover, the data being output to the server 1 may be stored in the data storing section 102 through the storing request section 101 (Step S5).

The storing request section 101, in order to allow a plurality of pieces of data to be stored, first adds an index indicating that the document data has been fed from the server 1 to the data, and then stores it into the data storing section 102.

Next, if the user wants to output the document created by the user using the server 1 to, for example, the server 2, the user presses down, for example, a function key F1 (not shown), with the keyboard 10 or the like being connected to the server 1, to instruct the storing request section 101 to duplicate the data being stored in the server 1 (Step S6).

In the data relaying system, when the function key, for example, is pressed down, until an escape key, for example, is pressed down next, the data input from the keyboard 10 or the like is output only to the storing request section 101 and is not output to the server switching section 100.

The storing request section 101, when being instructed to duplicate the data, first switches a connection to be selected by the output data switching section 111 from the server switching section 100 to the storing request section 101 (Step S7).

Then, the storing request section 101, through the output data switching section 111, makes a request of the server 1 to duplicate the data (Step S8).

Moreover, a device to be connected to the input data switching section 103 is switched in advance to the server 1 (Step S9).

Moreover, the switching of the device to be connected to the input data switching section 103 may be done by the server 1 having received a request for duplication of data. In this case, the server 1 does not feed duplicated data to the input data switching section 103 until a notification is returned that the switching of the device to be connected to the input data switching section 103 has been completed.

The server 1 duplicates data in response to a request from the storing request section 101 (Step S10).

The data to be duplicated is selected particularly in a following way. That is, the user selects the data, while keeping data containing the data to be duplicated displayed on a monitor being connected to the server 1 and while seeing the data being displayed on the monitor, for example, by pressing down a cursor key using the keyboard 10 or by dragging a part of the data that the user wishes to be duplicated by using the mouse 11.

When the user provides instructions for a request for duplication of the selected data by pressing down, for example, a control (Ctrl) key, an alternate (Alt) key or a shift key and a character “c” key using the keyboard 10, a signal produced by the instruction is transmitted to the server 1 through the storing request section 101. The server 1 makes duplication of the data in response to the request from the storing request section 101 by using software being installed.

Moreover, the above software is written so that the server 1, when doing the switching of a device to be connected to the input data switching section 103, feeds a request for the switching and receives notification to be returned from the input data switching section 103 that the switching of the device to be connected has been completed.

If the user wants to duplicate all data in a file in the server 1, the user can select the data to be duplicated by designating the file.

The server 1 outputs the duplicated data to the input data switching section 103 in the data relaying device 20. Since the input data switching section 103 connects the server 1 to the data storing section 102, only the duplicated data output from the server 1 is stored in the data storing section 102 (step S11).

In this case, an index, indicating that the document data has been input to the server 1 to the data, is added to the duplicated data by the input data switching section 103. Moreover, the index may be added in the order in which the duplicated data is stored or unwanted duplicated data may be deleted from the data storing section 102 by designating the index using the keyboard 10 or the like.

When an amount of the duplicated data exceeds a storage capacity of the data storing section 102, a deletion is made sequentially starting with the duplicated data being earlier stored.

Next, the storing request section 101 switches a connection to be selected by the output data switching section 112 to the storing request section 101 (Step 512).

Then, the storing request section 101 reads, by designating an index, the duplicated data out of data being stored in the data storing section 102 from the server 1 (Step S13).

The storing request section 101 outputs the duplicated data read from the data storing section 102 through the output data switching section 112 to the server 2.

The server 2 receives the duplicated data from the server 1 output through the output data switching section 112 (Step S14).

Here, the duplicated data is left in the data storing section 102 so that the duplicated data fed from the server 1 can be output also to the server N or a like.

Then, the user, when preferring to output the duplicated data fed from the server 1 being stored in, for example, the data storing section 102 to the server N, after having the storing request section 101 read the duplicated data, may output it through the output data switching section 11N to the server N.

It is apparent that the present invention is not limited to the above embodiments but may be changed and modified without departing from the scope and spirit of the invention.

What is claimed is:

1. A data relaying device for relaying data from a data inputting device to a plurality of servers and for outputting data input by said data inputting device to any one of said servers, said data relaying device comprising:
a storing request section to make a request for duplication of data being held by any one of said plurality of servers in accordance with instructions input by said data inputting device;
an inputting section to input data being duplicated according to a request from said storing request section;
a data storing section to store data input by said inputting section; and
an outputting section to output data being stored in said data storing section, in accordance with instructions input by said data inputting device, to another one or more of said plurality servers.

2. The data relaying device according to claim 1, further comprising a switching section to switch a device to be connected to any one of said plurality of servers between said data inputting device and said data storing section.

3. The data relaying device according to claim 1, wherein said storing request section stores data input by said data inputting device to said data storing section.

4. The data relaying device according to claim 1, wherein said data inputting device is at lease one of a keyboard, a mouse, a ten-key pad, a joy stick, and a track ball.

5. A data relaying system comprising:
a data inputting device;
a plurality of servers; and
a data relaying device for relaying data from said data inputting device to said plurality of servers and for outputting data input by said data inputting device to anyone of said servers, said data relaying system including: a storing request section to make a request for duplication of data being held by any one of said plurality of servers in accordance with instructions input by said data inputting device; an inputting section to input data being duplicated according to a request from said storing request section; a data storing section to store data input by said inputting section; and an outputting section to output data being stored in said data storing section, in accordance with instructions input by said data inputting device, to another one or more of said plurality servers.

6. The data relaying system according to claim 5, further comprising a switching section to switch a device to be connected to any one of said plurality of servers between said data inputting device and said data storing section.

7. The data relaying system according to claim 5, wherein said storing request section stores data input by said data inputting device to said data storing section.

8. The data relaying system according to claim 5, wherein said data inputting device is at lease one of a keyboard, a mouse, a ten-key pad, a joy stick, and a track ball.

9. A data relaying method comprising:
a step of outputting data input by a data inputting device to any one of a plurality of servers;
a step of duplicating data being held by any one of said plurality of servers and of storing the duplicated data to a data storing section in advance; and
a step of outputting data being stored in said data storing section to another one or more of said plurality of servers.

10. The data relaying method according to claim 9, further comprising a switching section to switch a device to be connected to any one of said plurality of servers between said data inputting device and said data storing section.

11. The data relaying method according to claim 9, wherein said storing request section stores data input by said data inputting device to said data storing section.

12. The data relaying method according to claim 9, wherein said data inputting device is at lease one of a keyboard, a mouse, a ten-key pad, a joy stick, and a track ball.
